(19) United States
(12) Patent Application Publication
(10) Pub. No.: US 2010/0151323 A1
(43) Pub. Date: Jun. 17, 2010

(54) ELECTRODE, ELECTRODE PASTE AND ELECTRONIC PARTS USING THE SAME

(75) Inventors: Takashi Naito, Funabashi (JP); Takahiko Kato, Hitachinaka (JP); Takuya Aoyagi, Hitachi (JP); Hiroki Yamamoto, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/635,731

(22) Filed: Dec. 11, 2009

(30) Foreign Application Priority Data
Dec. 12, 2008 (JP) 2008-316344
Jun. 11, 2009 (JP) 2009-139766

(51) Int. Cl. H01M 4/54; H01M 4/02

(52) U.S. Cl. 429/219; 429/220

(57) ABSTRACT

The objects of the present invention are to provide a copper-base electrode which can be calcined in an oxidative atmosphere, e.g., in air, like a silver electrode, and is less expensive than a silver electrode; an electrode paste; and electronic parts using it. The other objects of the present invention are to provide a copper-base electrode which can be calcined in an inert gas atmosphere, e.g., in nitrogen, at low temperature; an electrode paste; and electronic parts using it.

The electrode of the present invention contains at least metallic particles and an oxide phase, wherein the metallic particles contain copper and aluminum, and the oxide phase contains phosphorus. The oxide phase is preferably present as a phosphate glass phase in grain boundaries of the metallic particles. The electrode preferably contains the metallic particles and oxide phase at respective 75 to 95% and 5 to 25%, all percentages by volume. The metallic particles contain copper and aluminum at respective 80% or more and 3% or more for the calcination in an oxidative atmosphere, and 97% or more and 3% or less for the calcination in an inert gas atmosphere, all percentages by mass.

### FIELD OF THE INVENTION

The present invention relates to an electrode which can be produced at a low cost and calcined in an oxidative atmosphere, e.g., in air, electrode paste and electronic device part including the electrode. The present invention also relates to an electrode which can be calcined at low temperature in an inert gas atmosphere, e.g., in nitrogen, an electrode paste and electronic parts using the electrode.

### BACKGROUND OF THE INVENTION

Pure copper is used for an electrode for electronic parts (electronic device part) when the device, represented by LSI wiring, is produced by a process which involves no oxidative atmosphere. On the other hand, a silver electrode is used for a device, e.g., plasma display panel or photovoltaic cell, which is produced by a process involving heat treatment in an oxidative atmosphere, e.g., in air, because of its resistance to oxidation. For production of silver electrode, a paste comprising silver particles, a small amount of glass particles, resin binder and solvent is spread on a substrate of glass, silicon or the like and calcined in an electric oven or with laser beams at 500° C. or higher in air. The calcination softens/fluidizes the glass particles to give the dense electrode, and securely bond the electrode to the substrate.

Development of copper-base electrodes which can be calcined in air has been strongly demanded to replace the silver electrode, thereby reducing the electrode cost and improving resistance to migration of the metal. Patent Literature 1, for example, discloses an electronic device part material which improves weather resistance of copper as a whole by incorporating copper as the major ingredient with 0.1 to 3.0% by mass of molybdenum and evenly dispersing molybdenum in the copper grain boundaries. The technique with molybdenum as the essential ingredient tries to further improve weather resistance by incorporating one or more elements selected from the group consisting of aluminum, gold, silver, titanium, nickel, cobalt and silicon at a total content of 0.1 to 3.0% by mass. However, it is pointed out that the alloy conversely deteriorates weather resistance when one or more of the above elements are incorporated at a total content exceeding 3.0% by mass.

Normally, a thick copper electrode is produced by calcination carried out at a high temperature of 900 to 1000° C. in an inert gas atmosphere, e.g., in nitrogen, which may include steam, to sinter the copper particles with each other and thereby to reduce the electric resistance.

Patent Document 1: JP-A-2004-91907

### BRIEF SUMMARY OF THE INVENTION

As described above, development of copper-base electrodes which can be produced by calcination in air has been strongly demanded to replace the silver electrode, thereby reducing the electrode cost and improving resistance to migration of the metal. However, the copper base electrode produced by the conventional technique cannot replace the silver electrode for plasma display panels, photovoltaic cells or the like, because it has insufficient oxidation resistance to satisfy required electroconductivity.

Moreover, a copper electrode is difficult to calcine at low temperature, e.g., 500° C. even in an inert gas atmosphere, e.g., in nitrogen, because of its insufficient sinterability.

The objects of the present invention are to provide a copper-base electrode which can be calcined in an oxidative atmosphere, e.g., in air, like a silver electrode, and is less expensive than a silver electrode; an electrode paste; and an electronic device part including the electrode. The other objects of the present invention are to provide a copper-base electrode which can be calcined in an inert gas atmosphere, e.g., in nitrogen, at low temperature; an electrode paste; and an electronic device part including the electrode.

The electrode of the present invention contains at least metallic particles and an oxide phase, wherein the metallic particles contain copper and aluminum, and the oxide phase contains phosphorus. The oxide phase is present in grain boundaries of the metallic particles. The electrode preferably contains the metallic particles at 75 to 95%, particularly preferably 83 to 92%, and oxide phase at 5 to 25%, particularly preferably 8 to 17%, all percentages by volume.

In the electrode of the present invention, the metallic particles contain copper at 80% or more, preferably 85 to 97%, and aluminum at 3% or more, preferably 5 to 15%, all percentages by mass. It is preferable that the metallic particles comprise spherical particles having different particle diameters, plate-shape particles, or a mixture of the spherical particles and the plate-shape particles.

The oxide phase in the electrode of the present invention is of phosphate glass containing at least one element selected from the group consisting of vanadium, tungsten, molybdenum, iron, manganese, cobalt, tin, barium, zinc, aluminum, silver, copper, antimony and tellurium, of which vanadium or aluminum is particularly preferable. The vanadium-containing phosphate glass phase preferably contains at least two elements selected from the group consisting of tungsten, molybdenum, iron, manganese, barium, zinc, antimony and tellurium. The aluminum-containing phosphate glass is more effective when incorporated with copper.

The electrode of the present invention is produced by calcining an electrode paste comprising the metallic particles, particles which form the oxide phase, a resin binder and solvent in an oxidative atmosphere, e.g., in air. It may be produced by calcining an electrode paste comprising the metallic particles and a solution for forming the oxide phase in an oxidative atmosphere, e.g., in air.

The electrode and electrode paste of the present invention can find wide applicable areas as those for various electronic device parts. In particular, they are effectively applicable to plasma display panels, photovoltaic cells and so on.

Other objects, features and advantages of the invention will become apparent from the following description of the embodiments of the invention taken in conjunction with the accompanying drawings.

### ADVANTAGES OF THE INVENTION

The present invention provides a low-cost copper-base electrode which can be calcined in an oxidative atmosphere, e.g., in air, to replace a silver-base electrode for electronic device parts, e.g., plasma display panels, photovoltaic cells and so on, and also provides an electrode paste for production of the electrode.

The electrode of the present invention can be produced by calcination in an inert gas atmosphere, e.g., in nitrogen, at low temperature by containing the metallic particles and phosphate glass phase as the oxide phase, wherein the copper particles contain copper and aluminum at respective 97% or more and aluminum at 3% or less, all percentages by mass.

The electrode of the present invention, produced using a paste comprising the metallic particles and a solution for forming the oxide phase, can be mounted in various electronic device parts.

### BRIEF DESCRIPTION OF THE DRAWINGS

FIG. 1 illustrates a calcined condition of the electrode comprising the metallic particles and phosphate glass phase, wherein the metallic particles contain copper and aluminum, and oxide phase contains phosphorus.

FIG. 2 illustrates the relation between resistivity and calcination temperature with the electrode comprising the metallic particles and oxide phase, wherein the metallic particles contain copper and aluminum, and oxide phase contains phosphorus.

FIG. 3 illustrates the effects of the composition of the electrode on resistivity with the electrode comprising the metallic particles and oxide phase, wherein the metallic particles contain copper and aluminum, and oxide phase contains phosphorus.

FIG. 4 illustrates the relation between electrode resistivity and calcination temperature with the copper/aluminum composition for the metallic particles as the parameter.

FIG. 5 illustrates the effects of the composition on electrode resistivity with the copper- and aluminum-containing metallic particles of different particle diameter.

FIG. 6 illustrates the effects of the composition on electrode resistivity with the copper- and aluminum-containing metallic particles comprising plate-shape and spherical particles.

FIG. 7 is a cross-sectional view of a representative plasma display panel.

FIG. 8 is a cross-sectional view of a representative photovoltaic cell structure.

FIG. 9 illustrates a light-receiving plane of a representative photovoltaic cell structure.

FIG. 10 illustrates a back side of a representative photovoltaic cell structure.

FIG. 11 illustrates the relation between electrode resistivity and temperature of calcination carried out in a nitrogen atmosphere with the copper/aluminum composition for the metallic particles as the parameter.

FIG. 12 illustrates a condition of the electrode comprising the metallic particles and phosphate glass phase, calcined in a nitrogen atmosphere, wherein the metallic particles contain copper and aluminum.

### DETAILED DESCRIPTION OF THE INVENTION

The present invention is described in more detail.

It is known that pure copper particles, which are readily oxidized at 200° C. or higher in air, have improved oxidation resistance when incorporated with a second component, e.g., aluminum. However, aluminum alone cannot sufficiently improve oxidation resistance for electrodes. The inventors of the present invention have found that the copper- and aluminum-containing metallic particles have further improved oxidation resistance when coated with a phosphorus-containing oxide phase. The phosphorus-containing oxide phase is present in the grain boundaries of the metallic particles, and works to suppress or prevent oxidation of the metallic particles calcined at a high temperature in air, thereby preventing increase of electric resistance to make the composition effective for electrodes. However, the composition containing the metallic particles and oxide phase at respective below 75% by volume and above 25% by volume has an increased electric resistance because of increased distance between the metallic particles, although bringing the effect of preventing oxidation, and hence is unsuitable for electrodes. On the other hand, the composition containing the metallic particles and oxide phase at respective above 95% by volume and below 5% by volume cannot be densely sintered and is insufficiently adhesive to a substrate, and hence is unsuitable for electrodes. Therefore, the particularly preferable content ranges for electrodes are 83 to 92% for the metallic particles and 8 to 17% for the oxide, all percentages by volume.

The copper- and aluminum-containing metallic particles have increased electric resistance when the copper content is below 80% by mass, although preventing the oxidation, and are difficult to apply to electrodes. It is therefore preferable that the copper content is 85% by mass or more. However, the content of above 97% by mass, with the aluminum content below 3% by mass, accelerates oxidation of copper when the metallic particles are calcined at high temperature in air. The adequate aluminum content is 5 to 15% by mass, accordingly.

When the copper- and aluminum-containing metallic particles are spherical, they preferably comprise the particles of varying diameter rather than those of a uniform diameter, because they are packed more densely to further reduce the electric resistance. The plate-shape particles increase contact area between the particles to further reduce the electric resistance. A mixture of the spherical and plate-shape particles may be also used.

It is found that the phosphorus-containing oxide phase gives the electrode of dense texture and lowered electric resistance when incorporated with at least one element which forms a glassy phase with phosphorus, selected from the group consisting of vanadium, tungsten, molybdenum, iron, manganese, cobalt, tin, barium, zinc, aluminum, silver, copper, antimony and tellurium, of which vanadium gives the more effective electrode of lowered softening point and increased electron conductivity. The vanadium-containing phosphate glass phase secures reliability with respect to resistance to moisture, water or the like, when further incorporated with at least two elements selected from the group consisting of tungsten, molybdenum, iron, manganese, barium, zinc, antimony and tellurium. The electrode is produced with a paste comprising the copper- and aluminum-containing metallic particles, glass particles, a resin binder and solvent, which is spread on a substrate by printing and calcined in air.

The electrode with the copper- and aluminum-containing metallic particles treated with a phosphoric acid solution and calcined in air has the phosphate glass phase dispersed evenly and densely in the grain boundaries, and aluminum eluted and diffused into the glass phase from the metallic particles. It is found that copper in the above composition remains unoxidized even when calcined at high temperature in air to give the electrode of low electric resistance. Copper in addition to aluminum is sometimes eluted and diffused into the phosphate glass phase. The electrode is prepared with the copper- and aluminum-containing metallic particles dispersed in a phosphoric acid solution, spread on a substrate and calcined in air.

It is confirmed that the electrode can replace a silver electrode for plasma display panels and photovoltaic cells without causing any problem, and can go into various electronic device parts.

The metallic particles containing copper and aluminum at respective 97% by mass or more and 3% by mass or less can be calcined, when incorporated with an oxide phase of phosphate glass, at low temperature, e.g., 500° C., in an inert gas atmosphere, e.g., in nitrogen, to give a suitable electronic resistance for electrodes. Observation of the calcined electrode, after it is ground, indicates that the metallic particles are well sintered with each other, accelerated in the presence of the phosphate glass phase. However, the metallic particles containing copper and aluminum at respective below 97% by mass and above 3% by mass are insufficiently sintered with each other at low temperature, e.g., 500° C., to give an electrode of high electric resistance.

For the phosphate glass phase to be formed at low temperature, a phosphoric acid solution is more effective than powdered glass, because a phosphoric acid solution with which the metallic particles are treated is distributed into the whole metallic particles to allow them to be sintered with each other at low temperature substantially uniformly, and also to allow the phosphate glass phase to be formed stably at low temperature. Therefore, the solution gives a good electrode. The above procedure is effective for production of an electrode which can be calcined in an inert gas atmosphere, e.g., in nitrogen, for electronic device part, and gives the part at lower temperature.

The preferred embodiments of the present invention are described in detail by taking some representative examples.

### Example 1

An alloy containing copper and aluminum at respective 90% and 10% by mass was molten, and atomized with water to synthesize the spherical metallic particles containing copper and aluminum. The spherical particles were classified to produce those having a diameter below 8 μm for this example. The alloy had a bulk resistance of 1×10⁻⁵ Ωcm.

Table 1 gives the glass compositions prepared in Example 1.

TABLE 1

| | | | Thermal | |
|---|---|---|---|---|
| | | | expansion | Softening |
| | | Specific | coefficient | point |
| No. | Glass compositions | gravity | (×10⁻⁷/° C.) | (° C.) |
| G1 | V—P—Te—Ba—Fe—O composition | 3.4 | 98 | 405 |
| G2 | V—P—Sb—Ba—O composition | 3.3 | 72 | 423 |
| G3 | V—P—Mn—Ba—Te—O composition | 3.4 | 92 | 427 |
| G4 | V—P—Ba—W—Zn—Mn—K—Na—O composition | 3.6 | 103 | 447 |
| G5 | V—P—Ba—W—Zn—Fe—O composition | 3.5 | 77 | 455 |
| G6 | V—P—W—Mo—Ba—O composition | 4.0 | 82 | 474 |
| G7 | P—V—Sb—W—Zn—Ba—O composition | 3.8 | 79 | 526 |
| G8 | P—Zn—Ba—W—Fe—O composition | 3.2 | 87 | 545 |
| G9 | Sn—P—Zn—Ba—O composition | 3.5 | 110 | 445 |
| G10 | Pb—B—Si—Al—Zn—O composition | 7.2 | 112 | 406 |
| G11 | Bi—B—Ba—Zn—O composition | 6.5 | 105 | 462 |
| G12 | B—Zn—Ba—Si—Na—K—O composition | 3.2 | 88 | 545 |

Compositions G1 to G9 represent the phosphate glass with phosphorus as a vitrification component, and

Compositions G10 to G12 the borate glass with boron as a vitrification component. More specifically, Compositions G1 to G6 represent the phosphate glass with vanadium oxide as a major component, Compositions G7 and G8 the phosphate glass with phosphorus oxide as a major component, Composition G9 the phosphate glass with tin oxide as a major component, Composition G10 the borate glass with lead oxide as a major component, Composition G11 the borate glass with bismuth oxide as a major component, and Composition G12 the borate glass with boron oxide as a major component. Specific gravity of the glass was determined by the Archimedian method. Thermal expansion coefficient of the glass was determined by a thermal expansion meter with the 4 by 4 by 20 mm specimen in a temperature range from room temperature to 250° C. after drawing the thermal expansion curve. Quartz glass was used as the reference to convert the value. Softening point of the glass was determined by differential thermal analysis (DTA) with the powdered glass based on the second endothermic temperature. In Example 1, the glass compositions given in Table 1 were crushed to a diameter of 2 μm or less.

A paste was prepared by adding a resin binder and solvent to a mixture comprising 85% of the spherical metallic particles and 15% of the powdered glass given in Table 1, wherein ethyl cellulose and butylcarbitolacetate were used for the respective resin binder and solvent. The paste was spread on a glass substrate for a plasma display panel by screen printing, dried in air at 200° C. for 1 hour, and then heated by an electric oven in air at a heating rate of 5° C./minute to a temperature higher than the glass softening point by 50 to 60° C., at which it was held for 30 minutes, to prepare the calcined coating film, about 20 μm thick.

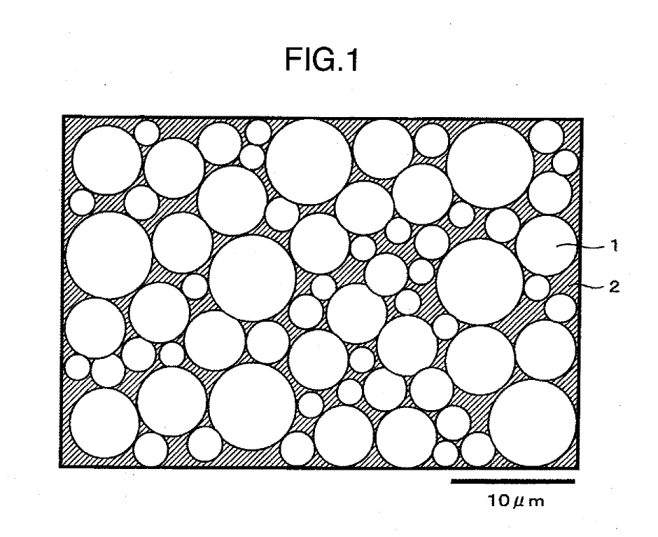

Resistivity of the calcined coating film was determined, after the upper face was ground to some extent, at room temperature by the 4-terminal method. Those films of Compositions G1 to G9 of the phosphate glass had a resistivity of 10⁻⁴ to 10⁻³ Ωcm, whereas those of Compositions G10 to G12 of the borate glass had a much higher resistivity of 10³ Ωcm or more. The observation of the calcined coating films of Compositions G1 to G9 of the phosphate glass by a scanning electron microscope (SED-EDX) indicated that they were densely sintered having the phosphorus-containing oxide phase 2 present in the grain boundaries of the copper- and aluminum-containing metallic particles 1, as illustrated in FIG. 1. The observation by X-ray diffractometry (XRD) indicated that these films showed the diffraction peaks only relevant to the metallic particles, and that the grain boundaries were composed of the phosphate glass phase. On the other hand, those films of Compositions G10 to G12 of the borate glass had a number of voids (bubbles) in the grain boundaries, resulting from the reactions of the copper- and aluminum-containing metallic particles with the borate glass, and had the metallic particles oxidized. It is thus found that the phosphate glass is effective for calcination of the metallic particles, making the calcined films applicable to electrodes.

Of the films of Compositions G1 to G9 of the phosphate glass, those of Compositions G1 to G6 containing vanadium oxide as a major ingredient had a low resistivity of the order of 10⁻⁴ Ωcm, and were effective for electrodes, conceivably because of high electron conductivity and low softening point of the glass. These glass compositions had a resistivity of 10⁵ to 10⁸ Ωcm, compared with insulation quality of the normal glass. These glass compositions had improved reliability with respect to vitrification stability and resistance to moisture, water or the like, when further incorporated with at least two elements selected from the group consisting of tungsten, molybdenum, iron, manganese, barium, zinc, antimony and tellurium.

For comparison, metallic particles of commercial pure copper were investigated in a similar manner. They were notably oxidized in any of the films of Compositions G1 to G12, and inapplicable to an electrode which can be calcined and formed in air.

### Example 2

The copper- and aluminum-containing metallic particles used in Example 1 were dispersed in a phosphoric acid solution, and possibility of the dispersion as a paste was studied. The solution contained phosphoric acid (H₃PO₄), purified water (H₂O) and ethanol (C₂H₅OH) at 10, 75 and 15% by mass, respectively, wherein ethanol was used to accelerate drying of the solution and make the dried solution less water-absorptive. For preparation of the paste, 100 parts by mass of the copper- and aluminum-containing metallic particles were dispersed in 30 parts by mass of the phosphoric acid solution while they were irradiated with ultrasonic waves for 30 minutes. The paste was spread on an alumina substrate by screen printing, dried in air at 150° C. for 1 hour, and then heated by an electric oven in air at a heating rate of 5° C./minute to 300 to 800° C., at which it was held for 30 minutes, to prepare the calcined coating film. The film had a thickness of about 20 μm, when heated at each temperature level.

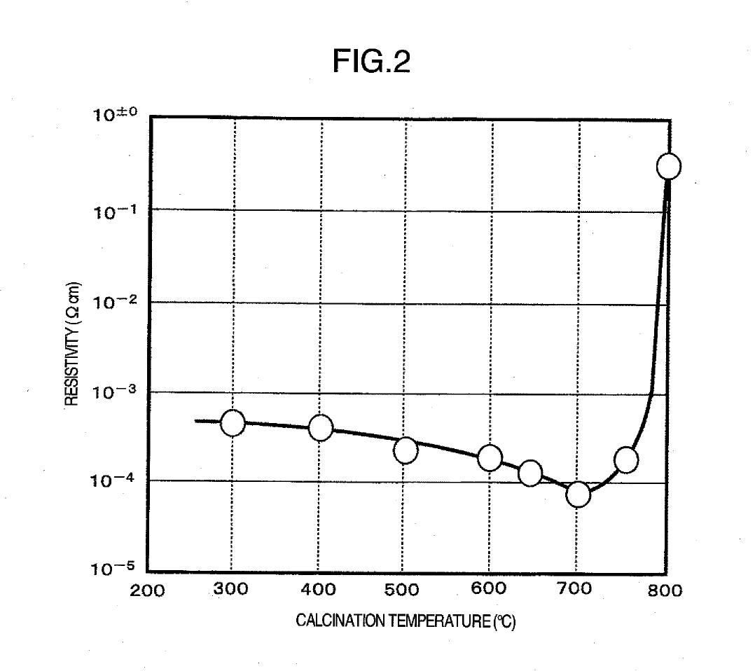

The film was analyzed for resistivity and by SEM-EDX, as in Example 1. FIG. 2 illustrates the relation between coating film resistivity and calcination temperature. As illustrated, the film had a good resistivity when heated at 300 to 750° C. even in air. Resistivity tended to decrease as temperature increased in a range from 300 to 700° C. However, it tended to increase as temperature increased to above 700° C., notably at 800° C. The film was densely sintered at any temperature level used, as revealed by the SEM-EDX analysis (FIG. 1). No oxidation was observed in the metallic particles calcined at 300 to 700° C., and sintering of the metallic particles with each other seemed to proceed as temperature increased, which conceivably accounted for resistivity decreasing with temperature. It was found that the grain boundaries were composed of the phosphorus-containing oxide phase, and that they contained more aluminum as temperature increased, suggesting that aluminum was eluted and diffused into the grain boundaries from the metallic particles faster as temperature increased to accelerate sintering of the metallic particles. However, the metallic particles had a lowered content of aluminum which worked to suppress oxidation of copper, when calcined at above 700° C. to trigger their oxidation, which conceivably accounted for the increased resistivity. This phenomenon was indicated by the SEM-EDX analysis results. Aluminum migrated from the metallic particles into the grain boundaries, when calcination temperature was increased to 800° C., to accelerate oxidation of the metallic particles. Copper was detected in the grain boundaries together with aluminum in the film calcined at 300 to 800° C., conceivably because copper was eluted into the phosphoric acid solution while the metallic particles were dispersed, due to acidity of the solution. The XRD analysis results indicated that the oxide phase present in the grain boundaries was of the phosphate glass phase containing aluminum and copper. The grain boundaries composed of the phosphate glass phase had improved chemical stability with respect to resistance to moisture, water or the like, because of the presence of aluminum.

For comparison, metallic particles of commercial pure copper were investigated in a similar manner. They were oxidized already at low 300° C., and inapplicable to an electrode which can be calcined and formed in air.

It is thus confirmed in Example 2 that the film calcined at 300 to 750° C. in air is applicable to electrodes.

### Example 3

Based on the findings obtained in Example 2, the phosphoric acid solution used in Example 2 was incorporated with each of cobalt, aluminum, silver and copper at 0.3 parts by mass per 100 parts by mass of the solution. The coating film was prepared by calcination carried out at 700 to 800° C. in air as in Example 2 to determine resistivity. The copper- and aluminum-containing metallic particles were the same as those used in Examples 1 and 2.

Resistivity of the film with any of cobalt, aluminum, silver and copper incorporated in the phosphoric acid solution was not notably increased even when it was calcined at 800° C., unlike the case illustrated in FIG. 2, falling in the first half of the order of 10⁻⁴ Ωcm, indicating that incorporation of the metallic ion beforehand in the phosphoric acid solution further improved oxidation resistance of the film calcined at high temperature in air, conceivably because of suppressed diffusion of aluminum from the metallic particles into the phosphate glass phase. Incorporation of the metal is effective for manufacture of an electrode by calcinations carried out at high temperature in air.

### Example 4

A total of 6 phosphoric acid solutions, P1 to P6, were investigated as in Example 2. These solutions are given in Table 2.

TABLE 2

| | Phosphoric Acid Solutions (% by mass) | | |
|---|---|---|---|
| | Phosphoric | Purified | |
| | Acid | water | Ethanol |
| No. | (H₃PO₄) | (H₂O) | (C₂H₅OH) |
| P1 | 5 | 80 | 15 |
| P2 | 10 | 75 | 15 |
| P3 | 15 | 70 | 15 |
| P4 | 20 | 65 | 15 |
| P5 | 30 | 55 | 15 |
| P6 | 50 | 35 | 15 |

Solution P2 given in Table 1 was the phosphoric acid solution used in Example 2. The copper- and aluminum-containing metallic particles used in Example 4 were the same as those used in Examples 1 to 3. For preparation of the paste, 100 parts by mass of the metallic particles were dispersed in 30 parts by mass of the phosphoric acid solution given in Table 2 while they were irradiated with ultrasonic waves for 30 minutes, as in Examples 2 and 3. The paste was spread on an alumina substrate by screen printing, dried in air at 150° C. for 1 hour, and then heated by an electric oven in air at a heating rate of 5° C./minute to 700° C., at which it was held for 30 minutes, to prepare the calcined coating film. Each of the films had a thickness of about 20 μm.

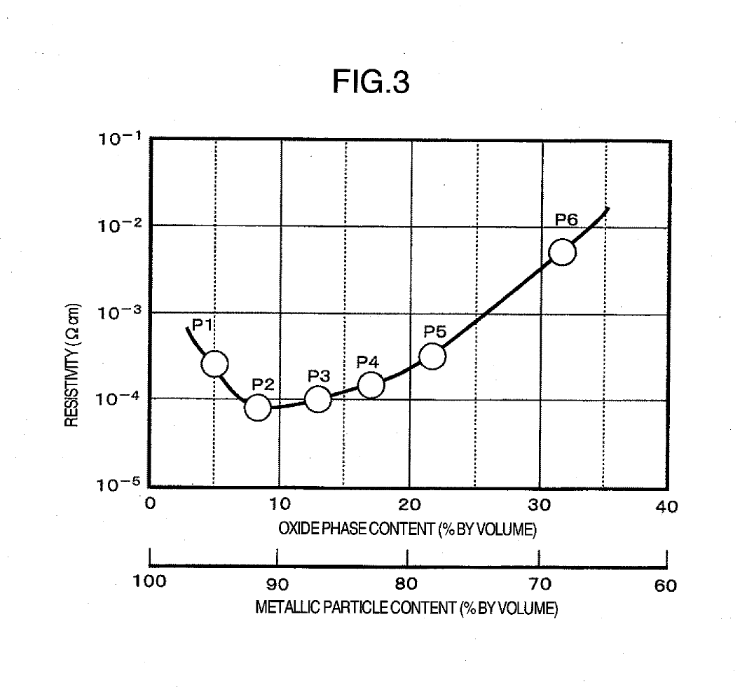

The film was analyzed for resistivity in a manner similar to that for Example 1. It was also analyzed by an SEM to determine the volumetric ratio of the metallic particles to the oxide phase in the grain boundaries by the area ratio. The ratio was 95/5 with Solution P1, 92/8 with Solution P2, 87/13 with Solution P3, 83/17 with Solution P4, 78/22 with Solution P5, and 68/32 with Solution P6. FIG. 3 illustrates the relation between film resistivity and the ratio. The film had a good resistivity of 10⁻³ Ωcm or less when it contains the oxide phase and metallic particles at respective 25% by volume or less and 75% by volume or more. The resistivity increased when the oxide phase content exceeded 25% by volume, conceivably because of expanded distance between the metallic particles. On the other hand, the oxide phase and metallic particles were not sufficiently adhesive to the alumina substrate when the film contained the oxide phase and metallic particles at respective 5 and 95% by volume. The film containing the oxide phase at below 5% by volume was difficult to apply to electrodes even when its resistivity was low. It is therefore judged that the film preferably contains the oxide phase and metallic particles at respective 5 to 25% by volume and 75 to 95% by volume to go into electrodes, more preferably 8 to 17% by volume and 83 to 92% by volume because of its lower resistivity and good adhesion of these components to the substrate.

The SEM-EDX and XRD analyses produced the results similar to those in Example 2, indicating that the oxide phase present in the grain boundaries was the phosphate glass phase containing at least aluminum, and copper in some cases.

### Example 5

A total of 7 types of spherical metallic particles containing copper and aluminum were prepared using the alloyed copper- and aluminum-containing particles given in Table 3, which were atomized with water as in Example 1. Example 5 used the particles classified to have a diameter below 8 μm.

TABLE 3

Copper/aluminum Alloy Compositions (% by mass)

| No. | Copper | Aluminum |
|---|---|---|
| C1 | 99 | 1 |
| C2 | 97 | 3 |
| C3 | 95 | 5 |
| C4 | 90 | 10 |
| C5 | 85 | 15 |
| C6 | 80 | 20 |
| C7 | 70 | 30 |

Composition C4 given in Table 3 represents the metallic particles used in Examples 1 to 4. Each of Compositions C1 to C7 was dispersed in Solution P2 given in Table 2 containing the aluminum ions while they were irradiated with ultrasonic waves, as in Example 3, wherein 0.5 parts by mass of aluminum was dissolved in Solution P2. The paste was spread on an alumina substrate by screen printing, dried in air at 150° C. for 1 hour, and then heated by an electric oven in air at a heating rate of 5° C./minute to a 300 to 1000° C., at which it was held for 30 minutes, to prepare the calcined coating film, as in Example 2. The film had a thickness of about 20 μm, when heated at each temperature level.

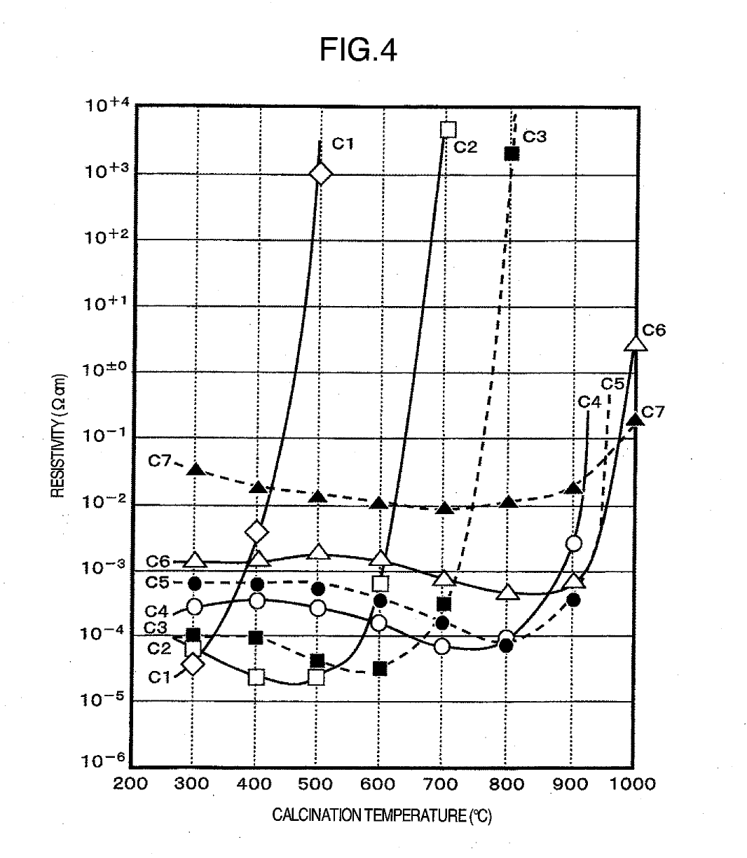

The film was analyzed for resistivity in a manner similar to that for Example 1. It was also analyzed by an SEM-EDX and XRD. The film was dense with any type of the metallic particles and calcined at any temperature used, having the aluminum-containing phosphate glass phase in the grain boundaries. FIG. 4 illustrates the relation between film resistivity and calcination temperature with the films of C1 to C7. Resistivity tended to decrease as copper content increased or aluminum content decreased in the lower-temperature region. In the higher-temperature region, on the other hand, resistivity conversely tended to decrease as copper content decreased or aluminum content increased. The film of C7 had an excessively high resistivity for electrodes, because of the insufficient copper content. The metallic particles of C6 had the lowest level of copper content, based on which it is considered that the copper content should be 80% by mass or more. The film of C5 had a resistivity of below 10⁻³ Ωcm when calcined in air at 300 to 900° C., based on which that the metallic particles preferably contain copper and aluminum at respective 85% by mass or more and 15% by mass or less. On the other hand, copper in the metallic particles of C1 was notably oxidized because of insufficient content of aluminum. Oxidation of copper in Composition C2 was prevented/suppressed when it was calcined in air at up to 500° C., and the composition is applicable to electrodes when calcined in the above temperature range, based on which it is considered that that the aluminum content should be at least 3% by mass in the metallic particles to suppress oxidation. Oxidation of copper in Composition C3 was prevented/suppressed when it was calcined in air at up to about 700° C., to keep film resistivity low, expanding the film applicable range, based on which it is considered that the aluminum content in the metallic particles is preferably 5% by mass or more.

It is thus found that the metallic particles contain copper at 80% or more, preferably 85 to 97%, and aluminum at 3% or more, preferably 5 to 15%, all percentages by mass, when they have the phosphate glass phase in the grain boundaries.

### Example 6

Example 6 studied the effects of particle diameter of the copper- and aluminum-containing metallic particles. The metallic particles in Composition C4 given in Table 3 having a diameter below 8 μm were classified to have two categories, one having an average diameter of 1 μm and the other 5 μm. Table 4 gives combinations of these categories, C41 to C45. A paste was prepared by dispersing 100 parts by mass of a combination given in Table 4 in 30 parts by mass of Solution P2 given in Table 2 while they were irradiated with ultrasonic waves for 30 minutes. The paste was spread on an alumina substrate by screen printing, dried in air at 150° C. for 1 hour, and then heated by an electric oven in air at a heating rate of 5° C./minute to 700° C., at which it was held for 30 minutes, to prepare the calcined coating film. Each of the films was about 20 μm thick.

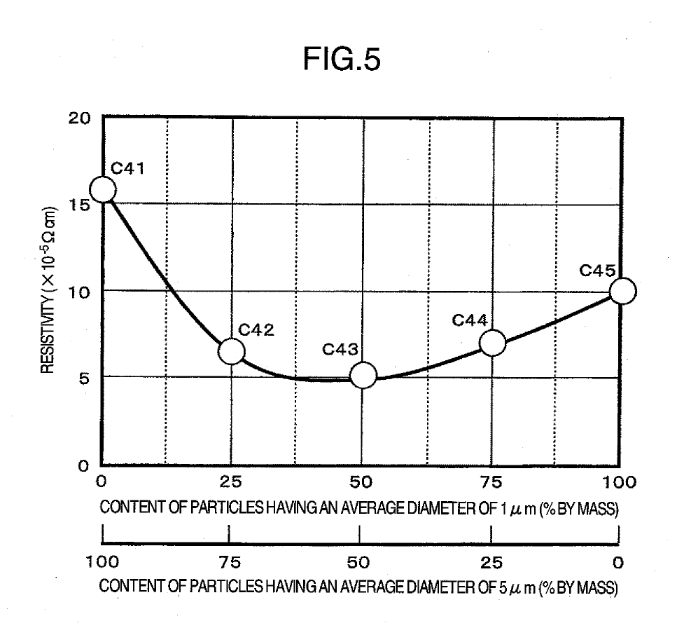

The film was analyzed for resistivity in a manner similar to that for Example 1. It was also analyzed by an SEM-EDX and XRD. Each of the films was dense with the phosphate glass phase containing at least aluminum in the grain boundaries. The aluminum was eluted/diffused from the metallic particles into the glass phase. FIG. 5 illustrates the relation between film resistivity and combination of the two particle categories of the calcined coating films in C41 to C45 of Table 4.

TABLE 4

Compositions of the two particle
categories of different particle
diameter (% by mass)

| | Average particle | Average particle |
|---|---|---|
| No. | diameter: 1 μm | diameter: 5 μm |
| C41 | 0 | 100 |
| C42 | 25 | 75 |
| C43 | 50 | 50 |
| C44 | 75 | 25 |
| C45 | 100 | 0 |

The results illustrated in FIG. 5 indicate that the film has a lower resistivity when the metallic particles are composed of the two particle categories of different particle diameter than that of the particles composed of the single category (C41 or C45), because of improved packing conditions, which was backed up by the SEM analysis results.

It is thus found that the film has a lowered resistivity when the metallic particles are composed of a combination of the particle categories each having a different diameter, and hence is suitable for electrodes.

### Example 7

Example 7 studied the effects of particle shape of the copper- and aluminum-containing metallic particles. First, the spherical particles of C4 given in Table 3 were classified to have an average diameter of 1 μm. The spherical particles were then ball-milled in the presence of an organic solvent to have plate-shape particles, which were annealed in a reducing atmosphere at 700° C. to improve their thermal stability. Example 7 also studied the mixtures of the plate-shape and spherical particles, wherein the spherical particles were those of C4 having an average diameter of 1 μm. Table 5 gives combinations of these spherical and plate-shape particles of C4, C401 to C405. A paste was prepared by dispersing 100 parts by mass of a combination of the plate-shape and spherical particles given in Table 5 in 30 parts by mass of Solution P2 given in Table 2 while they were irradiated with ultrasonic waves for 30 minutes. The paste was spread on an alumina substrate by screen printing, dried in air at 150° C. for 1 hour, and then heated by an electric oven in air at a heating rate of 5° C./minute to 700° C., at which it was held for 30 minutes, to prepare the calcined coating film. Each of the films was about 20 μm thick.

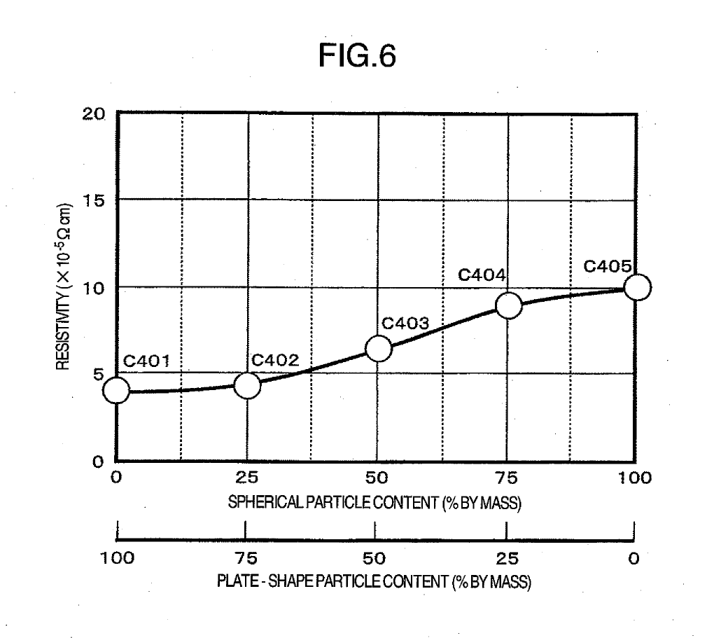

The film was analyzed for resistivity in a manner similar to that for Example 1. It was also analyzed by an SEM-EDX and XRD. Each of the films was dense with the phosphate glass phase containing at least aluminum in the grain boundaries. The aluminum was eluted/diffused from the metallic particles into the glass phase. FIG. 6 illustrates the effects of the composition C401 to C405 on coating film resistivity with the copper- and aluminum-containing metallic particles comprising plate-shape and spherical particles.

TABLE 5

Compositions of the spherical and
plate-shape particles (% by mass)

| No. | Plate-shape particles | Spherical particles |
|---|---|---|
| C401 | 100 | 0 |
| C402 | 75 | 25 |
| C403 | 50 | 50 |
| C404 | 25 | 75 |
| C405 | 0 | 100 |

The results illustrated in FIG. 5 indicate that film resistivity decreases as plate-shape particle content increases, because of improved contact conditions between the particles, which was backed up by the SEM analysis results.

It is thus found that the film has a lowered resistivity when the metallic particles are composed of plate-shape particles or a combination of the plate-shape and spherical particles, and hence is suitable for electrodes.

### Example 8

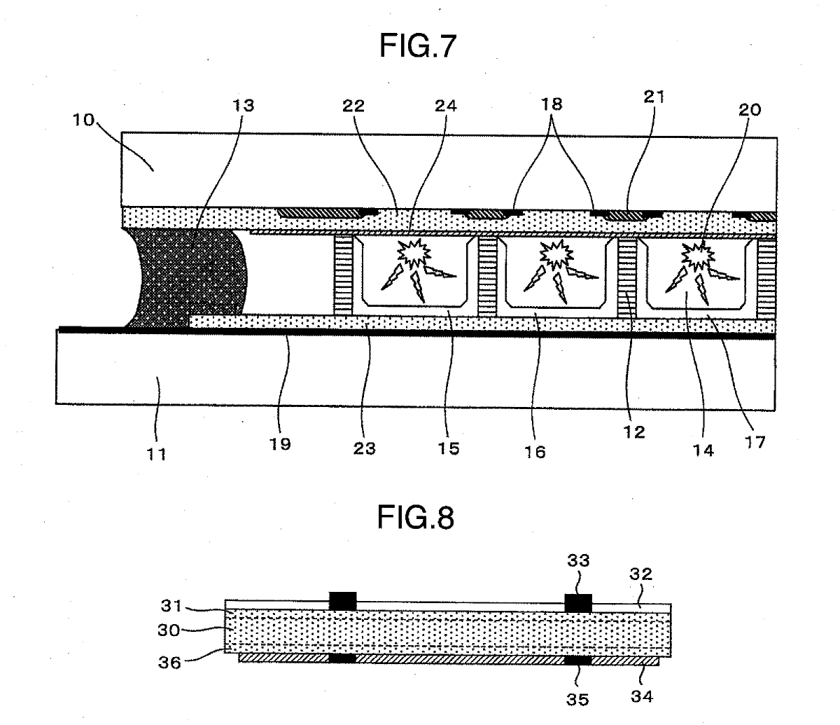

Example 8 describes the electrode of the present invention applied to a plasma display panel. FIG. 7 is a cross-sectional view of a representative plasma display panel.

The plasma panel has a front plate 10 and back plate 11, 100 to 150 μm apart from each other and disposed to face each other, wherein substrates are separated via diaphragm 12 to keep the space between them. The front plate 10 and back plate 11 peripheries are sealed air-tight by a sealing member 12, while the panel inside is filled with a noble gas. The fine space (cell 14) defined by the diaphragms 12 is filled with a fluorescent substance 15, 16 or 17 for respective red, green or blue color, and the cells of the three colors form a pixcel emitting these colors in accordance with the signals which it receives.

Each of the front plate 10 and back plate 11 is provided with electrodes regularly arranged on a glass substrate, wherein the electrode on the front plate 10 is a display electrode and that on the back 11 is a paired address electrode. A voltage of 100 to 200 V is applied selectively to between the electrode pairs in accordance with the display signals, to cause discharge between them and generate ultraviolet ray 20 which triggers the fluorescent substances 15, 16 and 17 to emit respective red, green and blue colors, and to display the colored images. The display electrode 18 and address electrode 19 are coated with respective dielectric layers 22 and 23 of thick glass film for protecting the electrodes and controlling discharged charges on the wall.

The back plate 11 is provided with diaphragms 12 on the dielectric layer 23 on the address electrode 19. The diaphragm has a striped or box-shape structure. A black matrix 21 (black band) may be disposed between the display electrodes in the adjacent cells to improve contrast.

A wiring of thick silver film is a normal choice at present for the display electrode 18 and address electrode 19. The wiring is preferably replaced by that of thick copper film to reduce the cost and prevent migration of silver. A copper electrode to go into plasma display panels should satisfy various conditions; oxidation of copper should be prevented while the wiring is calcined and formed in an oxidative atmosphere to prevent increase of electric resistance low, oxidation of copper should be prevented while the dielectric layer is calcined and formed in an oxidative atmosphere by the reactions between the wiring and dielectric layer to prevent increase of electric resistance, and formation of voids (bubbles), which deteriorate pressure resistance, in the vicinity of the wiring should be prevented. The display electrode 18, address electrode 19 and black matrix 21 may be formed by sputtering. However, printing is more preferable for reducing the cost. Printing is normally used for forming the dielectric layers 22 and 23. The display electrode 18, address electrode 19, black matrix 21, and dielectric layers 22 and 23, when formed by printing, are generally calcined in an oxidative atmosphere, e.g., in air, at 450 to 620° C.

The front plate 10 is totally coated with the dielectric layer 22, after the display electrodes 18 and black matrixes 21 are formed on the plate, to run at right angles to the address electride 19 on the back plate 11. The dielectric layer 22 is coated with a protective layer 24, normally of evaporated magnesium oxide (MgO), to protect the display electrodes 18 and others from the discharged charges. The back plate 19 is provided with the diaphragms 12 on the address electrode 19 and dielectric layer 23. The diaphragm is composed of a calcined structural material containing at least a glass composition and filler. The diaphragm may be formed with a volatile, grooved sheet deposited on the base, which is calcined at 500 to 600° C., after being filled with a paste for diaphragm in the groves, to evaporate the sheet. It may be also formed with a paste for diaphragm spread totally on the base, dried, masked, sand-blasted or chemically etched to remove unnecessary portions, and calcined at 450 to 500° C. The cell defined by the diaphragms is filled with a fluorescent substance 15, 16 or 17 paste which is calcined at 450 to 500° C., to form the respective fluorescent substance 15, 16 or 17.

The front plate 10 and back plate 10, normally prepared individually, are disposed to face and accurately aligned with each other, and then sealed with glass at 420 to 500° C. along the peripheries. The sealing material 13 is deposited beforehand on the peripheral area of the front plate 10 or back plate 11, normally on the back plate 11, with the aid of a dispenser or by printing. The sealing material 13 may be preliminarily calcined beforehand simultaneously with calcination of the red, green and blue fluorescent substances. This procedure greatly reduces bubbles in the glass-sealed portion to give highly air-tight and hence highly reliable seal. These plates are sealed with glass while releasing gases from the cell 14 and filling it with a noble gas under heating to form the panel. The sealing material 13 may directly come into contact with the display electrode 18 and address electrode 19, while it is temporarily calcined or the plates are sealed with glass, to react with the wiring material to increase its electric resistance. Therefore, it is necessary to prevent the reactions between them.

For lighting up the produced panel, a voltage is applied to a point at which the display electrode 18 and address electrode 19 intersect with each other, to cause discharge of the noble gas in the cell 14 to produce a plasma. The ultraviolet ray 20 generated when the noble gas in the plasma state returns back to the original state is used to trigger the red, green or blue fluorescent substance to emit light, light up the panel and display images. When a specific color is to be selectively emitted, address discharge is caused between the display electrode 18 and address electrode 19 in the cell 14 to be lighted up to accumulate charges on the walls in that cell. Then, a given voltage is applied to between the paired display electrodes to cause display discharge selectively in the cell with the charges accumulated on the walls by the address discharge. This generates the ultraviolet ray 20 to display images by triggering the fluorescent substance to emit light.

The plasma display panel was produced on a trial basis using the metallic particles C402 prepared in Example 7 and given in Table 5, and Solution P2 given in Table 2 for the display electrode 18 on the front plate 10 and address electrode 19 on the back plate 11. The plasma display panel is illustrated in FIG. 7. As in Example 7, 100 parts by mass of the metallic particles C402 were dispersed in 30 parts by mass of Solution P2 incorporated with a small amount of photosensitizing agent while they were irradiated with ultrasonic waves for 30 minutes, to prepare a paste for electrodes. The paste was spread to totally cover the front plate 10 and back plate 11 by screen printing, and dried in air at 150° C. The coated plates were then masked and irradiated with ultraviolet ray to remove the unmasked portions to form the front plate 10 and back plate 11, which were then calcined in air at 600° C. for 30 minutes. Next, the black matrix 21, and dielectric layers 22 and 23 were disposed and calcined in air at 610° C. for 30 minutes. The front plate 10 and back plate 11 were prepared individually, and sealed with glass along the peripheries. This produced the plasma display panel, illustrate in FIG. 7, on a trial basis. The display electrode 18 and address electrode 19 prepared using the electrode of the present invention showed neither oxidation-caused discoloration nor bubbles in the interfaces between the display electrode 18 and dielectric layer 22 and between the address electrode 19 and dielectric layer 23. These electrodes could be mounted in the plasma display panel apparently in good conditions.

The test was conducted to light up the trially produced plasma display panel. The panel was lighted up without increasing electric resistance of the display electrode 18 and address electrode 19, without deteriorating resistance to pressure of the panel, and without causing migration of the metal, unlike a silver electrode. No problem was observed in other areas, indicating that the electrode of the present invention is applicable to plasma display panels. It can replace a more expensive silver electrode and is expected to greatly reduce the cost.

### Example 9

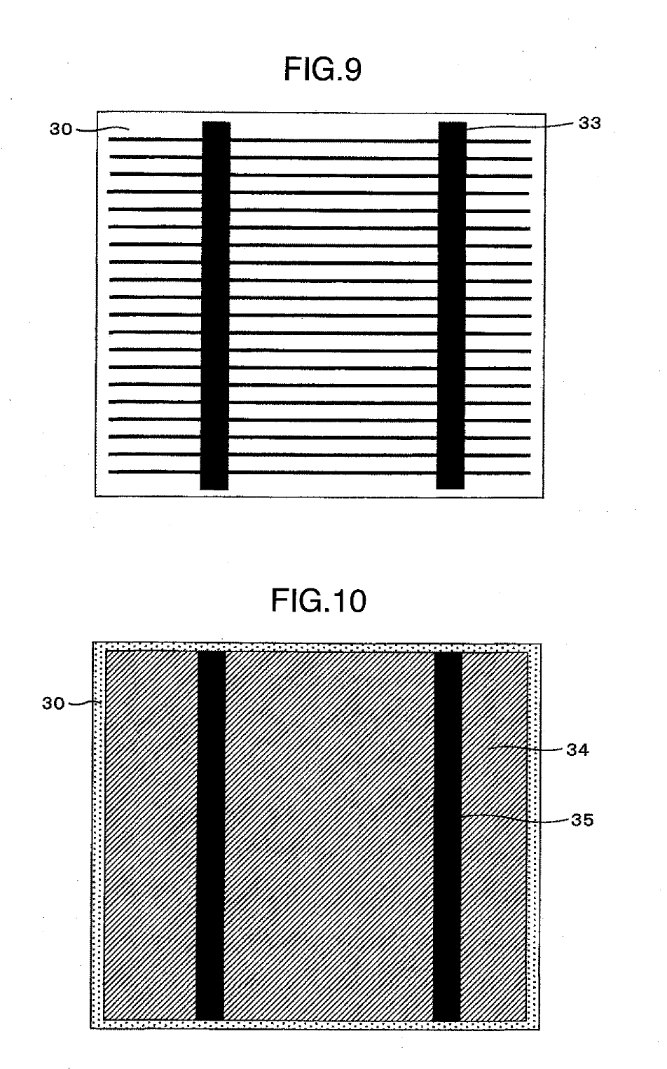

Example 9 describes the electrode of the present invention applied to a photovoltaic cell. FIG. 8 is a cross-sectional view of a representative photovoltaic cell, and FIGS. 9 and 10 outline respective its light-receiving plane and back plane.

A semiconductor substrate 30 of photovoltaic cell is normally of single- or poly-crystalline silicon or the like. The semiconductor substrate 30 is doped with boron or the like to be of p-type. The light-receiving side is etched to have roughened surface to suppress reflection of solar ray. The side is doped with boron or the like to form a diffusion layer 31 of n-type semiconductor having a thickness of sub-micron order, and also to form a pn junction in the interface with the bulk p-type portion. Moreover, the light-receiving side is coated with an around 100 nm thick antireflection layer 32 of silicon nitride or the like by an adequate method, e.g., vapor deposition.

Next, an electrode 33 formed on the light-receiving side, current-collecting electrode 34 formed on the back side and power output electrode 35 are described. Normally, a silver electrode paste containing glass particles is used for the electrode 33 on the light-receiving side and power output electrode 35, and aluminum electrode paste containing glass particles is used for the current-collecting electrode 34. These pastes are spread by screen printing. The paste is dried and then calcined in air at around 500 to 800° C. to form the electrode. The electrode 33 on the light-receiving side is electrically connected to the diffusion layer 31 after the glass composition in the electrode 33 reacts with the antireflection layer 32. On the back side, aluminum diffuses from in the current-collecting electrode 34 towards the back side of the semiconductor substrate 30 to form a layer 36 for diffusing the electrode components. As a result, the Ohmic contacts are formed between the substrate 30 and electrode 34, and between the substrate 30 and electrode 35.

The photovoltaic cell illustrated in FIGS. 8 to 10 was produced using the copper- and aluminum-containing metallic particles C43, prepared in Example 6 and given in Table 4, and Solution P2 given in Table 2 used to produce the electrode 33 on the light-receiving side and power output electrode 35. As in Example 6, 100 parts by mass of the metallic particles C43 were dispersed in 30 parts by mass of Solution P2 while they were irradiated with ultrasonic waves for 30 minutes, to prepare a paste for the electrodes 33 and 35.

First, an aluminum electrode paste for the current-collecting electrode 34 was spread on the back side of the semiconductor substrate 30 by screen printing, dried and heated by an infrared furnace for rapid heating in air to 600° C., at which it was held for 3 minutes. This produced the current-collecting electrode 34 on the back side of the semiconductor substrate 30, as illustrated in FIGS. 8 to 10.

Next, the paste for the electrodes 33 and 35 was spread on the light-receiving side of the semiconductor substrate 30, already provided with the diffusion layer 31 and antireflection layer 32, and on the back side of the substrate 30, already provided with the current-collecting electrode 34, by screen printing, dried and heated by an infrared furnace for rapid heating in air to 750° C., at which it was held for 1 minute. This produced the electrodes 33 and 35, as illustrated in FIGS. 8 to 10.

The photovoltaic cell produced in Example 9 had, on the light-receiving side of the semiconductor substrate 30 provided with the diffusion layer 31, the electrode 33 electrically connected to the s substrate 30. On the back side provided with the diffusion layer 36 for diffusing the electrode components, the Ohmic contacts were formed between the substrate 30 and current-collecting electrode 34, and between the substrate 30 and power output electrode 35. The electrode wiring resistance and contact resistance were substantially kept unchanged for 100 hours in the high temperature (85° C.), high humidity (RH: 85%) test.

It is thus found that the electrode of the present invention is applicable to photovoltaic cells, as well as plasma display panels described in Example 8. It can replace a more expensive silver electrode to reduce the cost.

A plasma display panel and photovoltaic cell are taken as representative applicable device parts for the electrode of the present invention. However, the electrode is applicable to wider areas, not limited to the above device parts. It can greatly reduce the cost of an electronic device part which includes a number of expensive silver electrodes.

### Example 10

Example 10 studied, based on the findings obtained in Example 5, whether the copper- and aluminum-containing metallic particles could be calcined at low temperature in an inert gas atmosphere. The metallic particles studied were those of the alloys C1 to C3 given in Table 3, spherical pure copper particles, and spherical metallic particles containing copper and aluminum at respective 99.5 and 0.5% by mass. They were classified to have an average diameter of 1 μm. Each of the 5 types of the metallic particles were dispersed in Solution P2 given in Table 2 to prepare a paste, wherein 100 parts by mass of the metallic particles were uniformly dispersed in 25 parts by mass of the solution while they were irradiated with ultrasonic waves for 30 minutes. The paste was spread on an alumina substrate by screen printing, dried in a drier kept at 80° C. for 2 hours, and then heated by an electric oven in a nitrogen gas atmosphere at a heating rate of 10° C./minute to 300 to 900° C., at which it was held for 30 minutes, to prepare the calcined coating film. The film had a thickness of about 20 μm, when heated at each temperature level.

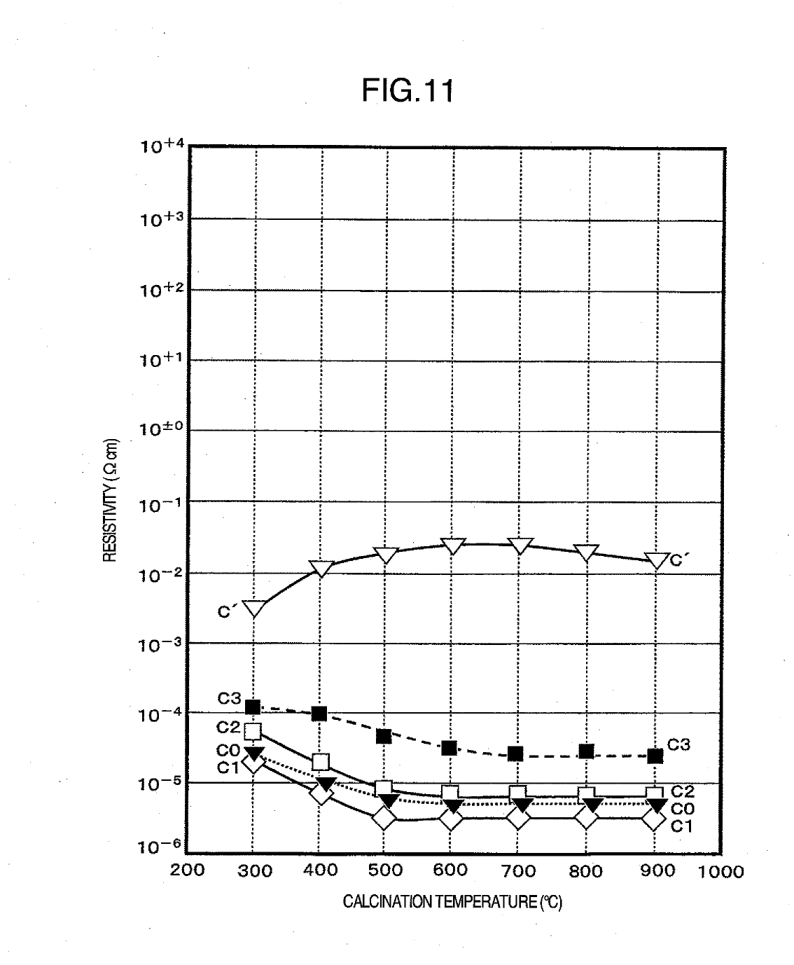

The film was analyzed for resistivity in a manner similar to that for Example 1. FIG. 11 illustrates the relation between film resistivity and temperature of calcination carried out in a nitrogen atmosphere, wherein C′: pure copper particles, C0: metallic particles containing copper and aluminum at respective 99.5 and 0.5% by mass, and C1 to C3: copper/aluminum alloy particles given in Table 3. The films of C0 to C2 had a good resistivity even when calcined at low temperature. It is particularly noted that the films of C0 and C1 had a resistivity of the order of 10⁻⁶ Ωcm when calcined at 400° C. or higher, and the film of C2 had a resistivity of the same order when calcined at 500° C. or higher. Accordingly, they are sufficiently applicable to electrodes. It is thus found that the film can be calcined at a much lower temperature than that for the common copper electrode, which needs a calcination temperature of 900 to 1000° C. in an inert gas atmosphere, e.g., in nitrogen. However, the calcined film of C3 had a higher resistivity than the films of C0 to C2, based on which it is found that the metallic particles preferably contain copper and aluminum at respective 97% or more and 3% or less by mass for low-temperature calcination in an inert gas atmosphere, e.g., in nitrogen. The completely aluminum-free film C′ of pure copper had a higher resistivity than the film of C3, by which is meant that it is important for the metallic particles to contain at least aluminum. Thus, the metallic particles preferably contain copper and aluminum at respective 97.0 to 99.5% and 0.5 to 3.0% by mass.

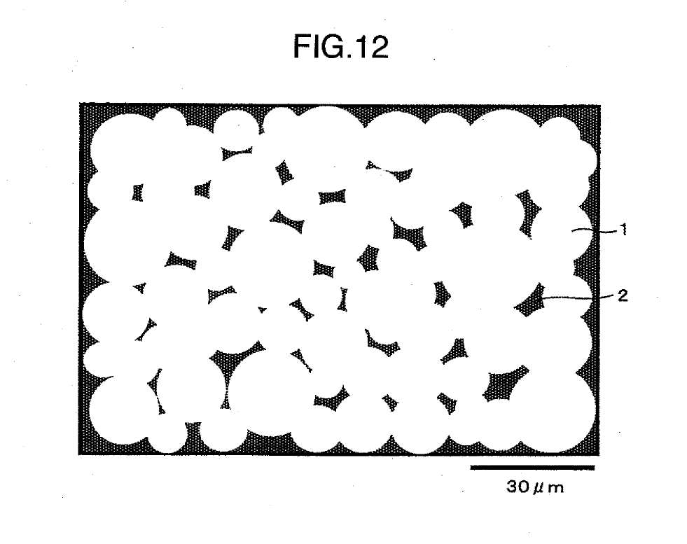

Next, the calcined films of C′ and C0 to C3 were analyzed by an SEM-EDX after they were ground. The film was densely calcined in the presence of Solution P2 given in Table 2 with any type of the metallic particles and at any calcination temperature used. As illustrated in FIG. 12, the films of C0 to C2 had the metallic particles 1 sintered with each other and grown even at low temperature. For example, the spherical metallic particles 1 having an average diameter of 1 μm were grown to about 20 μm at 500° C. This conceivably reduced resistivity of the film calcined at low temperature. The grain boundaries were composed of the phosphate glass phase 2, which contained copper and aluminum eluted from the metallic particles. It was particularly noted that most of aluminum in the metallic particles was eluted into the phosphate glass phase 2 during the calcination process. The elution of aluminum left behind the metallic particles of substantially pure copper, which, however, remained substantially unoxidized. It is thus found that the metallic particles are sintered with each other and grow even when calcined at low temperature on account of elution of aluminum and copper into the phosphate glass phase, which reduces resistivity of the film even at a low calcination temperature of around 500° C. as long as it is calcined in an inert gas atmosphere, e.g., in nitrogen, making the film applicable to electrodes.

As with the calcined films of C0 to C2, the calcined film of C3 showed no oxidation of the metallic particles, but had the metallic particles suppressed to sinter with each other and grow, conceivably because of its higher aluminum content to increase its resistivity. Calcination in air needs a higher content of aluminum in the metallic particles than calcinations in an inert gas atmosphere, because of accelerated elution of aluminum to reduce oxidation resistance of copper. The metallic particles preferably contain aluminum at a lower content, when calcined in an inert gas atmosphere than in air, because they can be calcined at a lower temperature.

In the calcined film of C′, the pure copper particles were observed to sinter with each other and grow, but were oxidized even when calcined in a nitrogen gas atmosphere, which conceivably accounted for its higher resistivity. It is considered that oxidation of the pure copper particles is caused by evaporation of water from Solution P2 during the calcination process. The metallic particles should contain aluminum to some extent. The effective metallic particles contain copper and aluminum at respective 97.0 to 99.5% and 0.5 to 3.0% by mass, and have the grain boundaries composed of the phosphate glass phase.

The electrode of the present invention can be calcined at temperature of about half of that for the conventional electrode, more specifically at about 500° C., for electronic device parts which can be produced in an inert gas atmosphere, e.g., in nitrogen, and is surely advantageous with respect to productivity and cost. Moreover, it can go into electronic device parts of low resistance to heat as a new applicable area.

It should be further understood by those skilled in the art that although the foregoing description has been made on embodiments of the invention, the invention is not limited thereto and various changes and modifications may be made without departing from the spirit of the invention and the scope of the appended claims.

### DESCRIPTION OF REFERENCE NUMERALS

1 Metallic particles containing copper and aluminum
2 Oxide phase containing phosphorus
10 Front plate
11 Back plate
12 Diaphragm
13 Sealing material
14 Cell
15 Red fluorescent substance
16 Green fluorescent substance
17 Blue fluorescent substance
18 Display electrode
19 Address electrode
20 Ultraviolet ray
21 Black matrix
22 Dielectric layer
23 Dielectric layer
24 Protective layer
30 Semiconductor substrate
31 Diffusion layer
32 Antireflection layer
33 Electrode on light-receiving side
34 current-collecting electrode
35 Power output electrode
36 Layer for diffusing electrode components

1. An electrode comprising:
at least metallic particles; and
an oxide phase,
wherein the metallic particles contain copper and aluminum, and the oxide phase contains phosphorus.

2. The electrode according to claim 1, wherein the oxide phase is present in grain boundaries of the metallic particles.

3. The electrode according to claim 1 which contains the metallic particles and oxide phase at respective 75 to 95% and 5 to 25%, all percentages by volume.

4. The electrode according to claim 1 which contains the metallic particles and oxide phase at respective 83 to 92% and 8 to 17%, all percentages by volume.

5. The electrode according to claim 1, wherein the metallic particles contain copper at 80% by mass or more.

6. The electrode according to claim 5, wherein the metallic particles contain copper at 85 to 97% by mass.

7. The electrode according to claim 1, wherein the metallic particles contain aluminum at 3% by mass or more.

8. The electrode according to claim 7, wherein the metallic particles contain aluminum at 5 to 15% by mass.

9. The electrode according to claim 1, wherein the metallic particles comprise spherical particles having different particle diameters.

10. The electrode according to claim 1, wherein the metallic particles comprise plate-shape particles.

11. The electrode according to claim 1, wherein the metallic particles comprise a mixture of spherical particles and plate-shape particles.

12. The electrode according to claim 1, wherein the oxide phase contains at least one element selected from the group consisting of vanadium, tungsten, molybdenum, iron, manganese, cobalt, tin, barium, zinc, aluminum, silver, copper, antimony and tellurium.

13. The electrode according to claim 12, wherein the oxide phase is a phosphate glass phase.

14. The electrode according to claim 12, wherein the oxide phase is a phosphate glass phase containing vanadium.

15. The electrode according to claim 14, wherein the oxide phase further contains at least two elements selected from the group consisting of tungsten, molybdenum, iron, manganese, barium, zinc, antimony and tellurium.

16. The electrode according to claim 12, wherein the oxide phase is a phosphate glass phase containing aluminum.

17. The electrode according to claim 16, wherein the oxide phase further contains copper.

18. An electrode paste comprising:
metallic particles containing copper and aluminum;
powders for forming the oxide phase containing phosphorus;
a resin binder; and
a solvent.

19. An electrode paste comprising:
metallic particles containing copper and aluminum; and
a solution for forming an oxide phase containing phosphorus.

20. An electronic part which includes the electrode according to claim 1.

21. An electronic part which includes an electrode formed by coating the electrode paste according to claim 18 and calcining in an oxidative atmosphere.

22. The electronic part according to claim 20 which is a plasma display panel or a solar cell element.

23. The electrode according to claim 1, wherein the metallic particles contain copper and aluminum at respective 97% or more and 3% or less, all percentages by mass.

24. An electrode paste comprising:
metallic particles containing copper and aluminum; and
a phosphoric acid solution forming a phosphate glass oxide phase.

25. An electronic part which includes the electrode according to claim 23.

26. An electronic part which includes an electrode formed by coating the electrode paste according to claim 24 and calcining at 500° C. or lower in an inert gas atmosphere.

27. An electronic part which includes an electrode formed by coating the electrode paste according to claim 19 and calcining in an oxidative atmosphere.
